(19) United States
(12) Patent Application Publication
(10) Pub. No.: US 2014/0020413 A1
(43) Pub. Date: Jan. 23, 2014

(54) THERMAL MANAGEMENT BY MEANS OF A TATANO-ALUMO-PHOSPHATE

(71) Applicants: Silke Sauerbeck, Bruckmuhl OT Heufeld (DE); Arno Tissler, Tegernheim (DE); Rolf Kurzhals, Landsbert OT Queis (DE)

(72) Inventors: Silke Sauerbeck, Bruckmuhl OT Heufeld (DE); Arno Tissler, Tegernheim (DE); Rolf Kurzhals, Landsbert OT Queis (DE)

(73) Assignee: Clariant Produkte(Deutschland)GmbH, Frankfurt am Main (DE)

(21) Appl. No.: 13/996,786

(22) PCT Filed: Dec. 21, 2011
(86) PCT No.: PCT/EP2011/073684

§ 371 Date: Sep. 27, 2013

(30) Foreign Application Priority Data
Dec. 22, 2010 (DE) 102010055677.7

(51) Int. Cl. B01J 20/28; B01J 20/08; B01J 20/18; F25B 17/08

(52) U.S. Cl. CPC B01J 20/28064; F25B 17/08; B01J 20/08; B01J 20/18
USPC 62/106; 62/480; 423/700; 252/194

(57) ABSTRACT

The present invention relates to a heat exchanger module with thermal management containing a titano-alumino-phosphate as adsorber, which displays a high hydrothermal stability and already desorbs the adsorbed water again under the action of low heat. By targeted action of temperature, the adsorbed water is condensed out, whereby heat energy is released. By means of the action of low heat, the condensed water can be adsorbed again as cold vapour on the adsorber, whereby heat energy is released. The heat exchanger module can be used to heat objects, appliances or rooms on the basis of the adsorption energy being released during the adsorption, as this is discharged and used further. In addition to heating, the cooling of rooms, objects and appliances is also possible, as the area surrounding the heat exchanger module is cooled due to a fall in the temperature in the heat exchanger module.

The present invention relates to a titano-alumino-phosphate as adsorbent in thermal management used in heat pumps, air-conditioning units, in catalysis or further heat exchangers.

Microporous structures such as zeolites which also include alumino-phosphates (APO), silico-alumino-phosphates (SAPO), titano-alumino-phosphates (TAPO) or titano-silico-alumino-phosphates (TAPSO) form a structurally diverse family of silicate minerals with complex structures. They occur naturally but are also manufactured synthetically. The minerals of this group, depending on the structure type, can store up to 40 percent of their dry weight as water which is released again when they are heated to 350 to 400° C. Through the regeneration, material is obtained which can be used again for drying.

However, it is not only alumino-silicate zeolites that display structural diversity and good adsorptivity, but also the group of alumino-phosphates. Structures of this group are classified by the “Structure Commission of the International Zeolite Association” on the basis of their pore sizes according to IUPAC rules (International Union of Pure and Applied Chemistry). As microporous compounds they have pore sizes of from 0.3 nm to 0.8 nm. The crystal structure and thus the size of the pores and channels formed is controlled by synthesis parameters such as pH, pressure and temperature. The porosity is further influenced by the use of templates during synthesis as well as the Al/P/Ti/(Si) ratio. They crystallize into more than two hundred different variants, into more than two dozen different structures, which have different pores, channels and cavities.

Because of the equal number of aluminium and phosphorus atoms, alumino-phosphates are neutral in charge. Titano-silico-alumino-phosphates (TAPSO) form as a result of the isomorphic substitution of phosphorus with titanium and silicon. As a result of the incorporation of the cations the properties of the titano-silico-alumino-phosphates (TAPSO) can be set and modified. The level of phosphorus-silicon/titanium substitution thus determines for example the number of cations required for balancing, and thus the maximum charging of the compound with positively charged cations, e.g. hydrogen or metal ions.

The framework structures of the titano-alumino-phosphates are constructed from regular, three-dimensional spatial networks with characteristic pores and channels which can be linked with each other in one, two or three dimensions.

The above-mentioned structures are formed from corner-connected tetrahedral units (AlO₄, PO₄, TiO₄, optionally SiO₄), consisting respectively of aluminium and phosphorus as well as optionally silicon tetracoordinated by oxygen. The tetrahedra are called primary structural units the connecting of which results in the formation of secondary structural units.

Titano-alumino-phosphates, silico-alumino-phosphates and titano-silico-alumino-phosphates are usually obtained by means of hydrothermal synthesis starting from reactive gels, or the individual Ti, Al, P, and optionally Si components. Titano-alumino-silico-phosphates (TAPSO) are produced analogously to silico-alumino-phosphates (SAPO) (DE 102009034850.6). These can be obtained in crystalline form by adding structure-directing templates, crystal nuclei or elements (e.g. EP 161488).

Titano-alumino-phosphates are used primarily as catalysts in MTO (methanol-to-olefin conversion) processes in which, starting from methanol, a mixture of ethene and propene can be obtained with the aid of specific microporous catalysts.

Alumino-phosphates are popularly used in dehydration reactions (EP 2 022 565 A1) due to their good hygroscopic properties and their high adsorption capacity.

The adsorption capacity of the titano-silico-alumino-phosphates is particularly good due to the microporous framework structure. Titano-alumino-phosphates also display good adsorption behaviour as a large number of molecules can be adsorbed on the large surface area. If water molecules strike the surface of the titano-alumino-phosphate, they are adsorbed. An exothermic accumulation takes place in particular on the inner surface, accompanied by the release of the kinetic energy of the water molecules as well as their adsorption energy which is released in the form of adsorption heat. The adsorption is reversible, wherein desorption represents the reverse process. In general, adsorption and desorption are present in a concurrent equilibrium which can be controlled and influenced by temperature and pressure.

Zeolites and silico-alumino-phosphates are known in the state of the art on the basis of their high water adsorption capacity and are therefore used as adsorbents in heat pumps (EP 1652817 A1).

A zeolite heat exchanger consists of an evacuated, hermetically sealed module which is equipped with an adsorber or desorber at one end and an evaporator or condenser at the other end. In a first step the adsorber or desorber zeolite is heated in the desorption phase to up to 80° C. to 150° C. for example with the aid of a gas fuel cell or another heat source. As zeolites can release adsorbed water again at high temperatures, the water desorbs, is removed from the adsorber zeolite and is conveyed in the hot air stream, as hot water vapour, into the colder, i.e. non-heated, area of the module. In the colder area, the hot water vapour condenses, accompanied by the release of heat energy which is discharged and used as useful heat. The adsorber zeolite is heated until all of the adsorbed water is desorbed. After completed desorption, a dry adsorber is obtained which switches off the gas fuel cell, as a result of which the temperature in the area of the evaporator or condenser in the module cools to is below ambient temperature. As soon as the temperature of the dry adsorber zeolite has fallen below the ambient temperature, heat is added from outside, so that the water condensed out is heated and can be adsorbed at the other end as cold vapour. Adsorption heat forms, which can be discharged as useful heat. The cycle ends with the complete evaporation of the water, and a new adsorption and desorption cycle can begin.

In addition to zeolites, silico-alumino-phosphates are also used as adsorbents in such heat pumps. Silico-alumino-phosphates are characterized by much lower desorption temperatures. As the temperatures lie in the range of from 50° C. to 100° C., significant energy savings can be made here compared with the zeolite adsorbers. Because of the high adsorptivity with low expenditure of energy necessary for the regeneration of the aqueous silico-alumino-phosphate, silico-alumino-phosphates are preferably used as heat exchanger materials in such devices. Small-pored silico-alumino-phosphates (pore size 3.5 Å) with CHA structure are preferably used, preferably SAPO-34. Despite the good adsorption capacity and low regeneration temperature, silico-alumino-phosphates are suitable for use as adsorbents in heat exchanger devices only to a limited extent because they already amorphize at low temperatures under hydrothermal conditions and thus quickly lose their adsorption capacity. For SAPO-34 it is not possible to provide the adsorbent as a shaped body or honeycomb structure which makes a simplified handling of the adsorption material possible, as a slurrying in aqueous phase is already sufficient to destroy the typical CHA framework structure. Longer contact with water means that the adsorbent would already have to be changed after 1-2 cycles, which would result in high material costs, making this method unusable.

Thus, no heat exchangers with energy-efficient adsorbents are known from the state of the art which, in addition to high adsorption capacity, low regeneration and desorption temperature, also display a good long-term stability vis-à-vis hydrothermal conditions, in order to be used as adsorbents in heat exchangers. The long-term stability of the framework structure and energy-efficient regeneration of the adsorbent for desorption of the adsorbed water represent a particular problem the solution to which is to date not known from the state of the art.

The object of the present invention was therefore to provide an adsorbent which, in addition to a high adsorption capacity, has a low regeneration and desorption temperature and also displays in particular a high long-term stability vis-à-vis hydrothermal conditions over a broad temperature range, and thus makes the use as adsorbent in heat exchangers possible.

According to the invention, this object is achieved by a heat exchanger module with thermal management with a titano-alumino-phosphate as adsorbent. Adsorbed water can already desorb in titano-alumino-phosphates by the action of low heat.

In addition to high adsorption capacity, they also display a high hydrothermal stability of the framework structure and can thus be used in heat exchangers over many cycles.

By “thermal management” is meant according to the invention a utilization of heat to regenerate the aqueous adsorbent. As low temperatures already suffice to reversibly desorb adsorbed water from titano-alumino-phosphates, this can take place for example by residual heat, ambient heat, solar energy. The use of residual heat serves to regenerate the aqueous alumino-phosphate which can be used again after desorption.

Furthermore, by “thermal management” is meant that the heat energy released by the adsorption process at the adsorbent is discharged and made usable. Because of the reversible bonding of the water molecules in the framework structure of the molecular sieve, in each case a certain amount of energy is released, whereby the area surrounding the adsorbent is heated. This heat can be collected, stored, transferred and/or, as needed, discharged again by collectors and further customary heat-storage media, such as for example latent heat stores, buffer stores, thermochemical heat stores, sorption stores, regenerators or aquifers.

By “thermal management” is meant further that the regeneration of the aqueous titano-alumino-phosphate is facilitated by the utilization of stored heat energy. Some of the adsorbed water already desorbs from the aqueous titano-alumino-phosphate because of the stored heat energy. The remaining adsorbed water can be removed by low heat expenditure, as a result of which the energy costs can be kept low or can be reduced compared with other adsorbents.

By “thermal management” is also meant that, because of the energy being released, the aqueous adsorbent is present already pre-heated, whereby only a little heat needs to be added in order to remove the water again and obtain regenerated adsorbent. As a result of energy already being obtained with the adsorption of water, even less energy is needed to regenerate and desorb the water from the aqueous adsorbent, whereby the energy costs can be reduced, and thus savings can be made on costs.

By the term “thermal management” is also meant according to the invention the use of the adsorption heat of an adsorbent, which forms as a result of the adsorption of water on a surface. This adsorption heat is released in the form of heat and can be used to remove residual moisture from reception spaces, chambers, reactors, objects or appliances in thermal contact with it. These are pre-heated by the adsorption heat and can thus have residual moisture removed from them more easily. The adsorption heat can also be used to heat liquids, rooms, appliances or devices, etc. This means advantageously that energy costs can be lowered.

By “thermal management” is meant further that, by the water condensing out, heat energy is released which can be collected, stored, transferred and/or, as needed, discharged again by collectors and further customary heat storage media, such as for example latent heat stores, buffer stores, thermochemical heat stores, sorption stores, regenerators or aquifers.

By “thermal management” is meant further that a cooling is also facilitated. As a result of the heat-induced desorption and subsequent condensation of the water, the surrounding area cools down, whereby rooms, object, appliances, devices, etc. can be already pre-cooled and less energy is needed to cool them down.

By “thermal management” is meant further that the amount of heat needed for desorption can also be removed from the “surrounding area” in contact with it, whereby the room, object, appliances, devices, etc. cool down, and are thus already pre-cooled, whereby less energy needs to be applied for cooling.

By “regeneration” is meant according to the invention the heat-induced recovery of usable adsorbent starting from aqueous adsorbent. The aqueous titano-alumino-phosphate becomes usable again due to the action of heat and can be fed back into a cycle of adsorption and desorption.

In addition to water, any other adsorbable solvent, such as acetone, ethanol or the like, can also be used which displays a phase transition from liquid to gas at relatively low temperatures, such as e.g. between room temperature and 100° C. The choice also depends on the adsorbent, and its affinity to corresponding solvents, as the adsorptivity should be as high as possible, in order for there to be maximum occupation of the adsorption sites.

It was surprisingly found that titano-alumino-phosphates are suitable for use as adsorbents in heat exchangers. Because of their good water adsorption capacity, titano-alumino-phosphates can be used very well as adsorbents for removing water from objects and appliances, as they furthermore also display a high long-term stability vis-à-vis water and in particular hydrothermal conditions. As the adsorption capacity of the titano-alumino-phosphates is much higher than the adsorption capacity of zeolites and alumino-phosphates, the quantity of adsorbent needed can be reduced with the same adsorption capacity, which saves on costs, material and energy.

The adsorption capacity of the titano-alumino-phosphates, the metal-exchanged as well as doped titano-alumino-phosphates as well as the titano-alumino-silico-alumino-phosphates, metal-exchanged as well as doped titano-alumino-phosphates is particularly good because of the microporous framework structure. Titano-alumino-phosphates display good adsorption behaviour as a large number of molecules can be adsorbed on the large surface area because of their microporous framework structure. The adsorption process begins as soon as water molecules strike the surface of the titano-alumino-phosphate. During the adsorption of the water molecules on the surface of the titano-alumino-phosphate, a reversible exothermic accumulation takes place on the surface, accompanied by the release of the kinetic energy of the water molecules as well as the adsorption energy which is released in the form of adsorption heat. The adsorption is reversible and can be reversed by input of energy. The desorption represents the reversed, endothermic process which only begins if energy in the form of heat is fed into the system. The adsorbed water molecules detach themselves from the surface of the titano-alumino-phosphate, are heated, and change into the gas phase as water vapour. Adsorption and desorption represent a concurrent equilibrium which can be controlled and influenced and shifted by temperature and pressure.

Surprisingly, titano-alumino-phosphates can be used as thermal management materials for adsorbing water, as a regeneration of the aqueous adsorbent can already take place as a result of the action of low heat or residual heat in the surrounding area, e.g. by means of pre-heated air streams.

Thus, a simplified and faster regeneration of the aqueous titano-alumino-phosphate takes place by using the temperatures prevailing in the surrounding area, or as a result of the energy from the adsorption process itself, stored in the storage media. According to the invention, water is thus adsorbed which releases a certain amount of heat energy which can be used again to regenerate the adsorbent.

As a result of the use of titano-alumino-phosphates in heat exchangers, any amount of energy can thus be further utilized, and no energy (adsorption energy or condensation heat) is lost, instead it is utilized further.

The heat exchanger module with thermal management according to the invention contains a titano-alumino-phosphate as adsorbent which, because of the high adsorption capacity, low regeneration temperature and hydrothermal stability, can already be regenerated by a small input of energy. In addition, using thermal management, adsorption energy and further energy being released can further be made usable by energy storage devices.

A titano-alumino-phosphate which is a regenerative titano-alumino-phosphate (TAPO) or titano-silico-alumino-phosphate (TAPSO) is preferably used as adsorbent. As a result of the substitution of silicon for phosphorus, the adsorption properties are improved and even more water can be adsorbed with the same quantity of adsorbent, but the stability vis-A-vis water at low and high temperatures is also increased, whereby the structure does not amorphize under the action of water over many heat exchanger cycles, but the titano-alumino-phosphates or titano-silico-alumino-phosphates remain further usable.

Regenerative means that the aqueous adsorbent reversibly releases the adsorbed water under the action of heat. The titano-alumino-phosphate or titano-silico-alumino-phosphate is thereby regenerated, and can be used again for adsorption.

In one embodiment of the invention, microporous titano-alumino-phosphates (TAPO) of the following type can be used: TAPO-5, TAPO-8, TAPO-11, TAPO-16, TAPO-17, TAPO-18, TAPO-20, TAPO-31, TAPO-34, TAPO-35, TAPO-36, TAPO-37, TAPO-40, TAPO-41, TAPO-42, TAPO-44, TAPO-47, TAPO-56.

TAPO-5, TAPO-11 or TAPO-34 are particularly preferably used because they display a particularly high hydrothermal stability vis-à-vis water.

TAPO-5, TAPO-11 and TAPO-34 are also particularly suitable because of their good properties as adsorbent and because of the low regeneration temperature. According to the invention the use of microporous titano-alumino-phosphates with CHA structure is particularly suitable.

In addition to silicon, the titano-alumino-phosphates according to the invention can also contain other metals. Some of the phosphorus can also be replaced by silicon, iron, manganese, copper, cobalt, chromium, zinc and/or nickel. These are usually called SiTAPOs, FeTAPOs, MnTAPOs, CuTAPOs, CoTAPOs, CrTAPOs, ZnTAPOs, CoTAPOs or NiTAPOs. The types MTAPO-5, MTAPO-8, MTAPO-11, MTAPO-16, MTAPO-17, MTAPO-18, MTAPO-20, MTAPO-31, MTAPO-34, MTAPO-35, MTAPO-36, MTAPO-37, MTAPO-40, MTAPO-41, MTAPO-42, MTAPO-44, MTAPO-47, MTAPO-56 (with M=Si, Fe, Mn, Cu, Co, Cr, Zn, Ni) are particularly suitable.

MTAPO-5, MTAPO-11 and MTAPO-34 are particularly preferred because of their good properties as adsorbent and because of the low regeneration temperature. According to the invention the use of microporous titano-alumino-phosphates with CHA structure is particularly suitable.

In addition to silicon, the titano-alumino-phosphates according to the invention can also contain further metals. Ion exchange with titanium, iron, manganese, copper, cobalt, chromium, zinc and nickel has proved particularly advantageous. FeTAPSO, MnTAPSO, CuTAPSO, CoTAPSO, CrTAPSO, ZnTAPSO and NiTAPSO are particularly suitable.

According to the invention the titano-alumino-phosphates can also be present doped, in which metal is incorporated into the framework. It has proved particularly advantageous to dope with silicon, iron, manganese, copper, cobalt, chromium, zinc and nickel. FeTAPO, MnTAPO, CuTAPO, CrTAPO, ZnTAPO, CoTAPO and NiTAPO are particularly suitable.

Microporous MTAPOs (M=Mn, Cu, Cr, Zn, Co, Ni), such as MTAPO-5, MTAPO-8, MTAPO-11, MTAPO-16, MTAPO-17, MTAPO-18, MTAPO-20, MTAPO-31, MTAPO-34, MTAPO-35, MTAPO-36, MTAPO-37, MTAPO-40, MTAPO-41, MTAPO-42, MTAPO-44, MTAPO-47 and MTAPO-56 are particularly suitable.

MTAPO-5, MTAPO-11 or MTAPO-34 are particularly preferably used. This is particularly advantageous as by the incorporation of one or more further metals, the adsorption properties and the hydrothermal stability of the titano-alumino-phosphates is further increased.

By the term metal exchange is also meant, according to the invention, a doping with metal or semi-metal. It means the same, whether the exchange takes place in the framework and metal ions were integrated into the structure, or whether the exchange was carried out subsequently and only cations X are replaced by other metal cations M.

Surprisingly titano-alumino-phosphates according to the invention which are used in a heat exchanger module according to the invention display a high hydrothermal stability up to 900° C. It is necessary to distinguish between whether the titano-alumino-phosphate according to the invention is used in hot water, wherein it displays a hydrothermal stability up to 100° C., or is exposed to a hot water vapour atmosphere, and remains stable up to 900° C. This is particularly advantageous because in particular the hydrothermal stability at high and low temperatures is important, as titano-alumino-phosphates are already regenerated again at a low desorption temperature of from 20° C. to 100° C., preferably at a temperature of from 30° C. to 90° C., preferably at a temperature of from 40° C. to 80° C. Because they do not display any tendency to amorphization like silico-alumino-phosphates, but display a much higher structure stability under hydrothermal conditions, with a lower desorption temperature compared with zeolites or alumino-phosphates, many cycles of adsorbing and desorbing can thus be passed through without the adsorbent needing to be replaced. Furthermore, the energy costs necessary for regenerating the adsorbent are significantly reduced.

Surprisingly, the small-pored molecular sieve according to the invention displays a greater thermal stability in aqueous phase than hitherto known molecular sieves not containing titanium which have been used as adsorbent in comparable devices. The high stability of the titano-alumino-phosphate vis-à-vis hydrothermal stress, such as forms in the case of repeated use as adsorber/desorber, in particular at temperatures in the range of from 50° C. to 100° C., is particularly advantageous. It is particularly advantageous for the hydrothermal long-term stability if the titano-alumino-phosphate according to the invention has a partial exchange of phosphorus with silicon.

In the long-term stress test it has been shown that, compared with silico-alumino-phosphates at 30° C., titano-silico-alumino-phosphates at up to 90° C. over longer periods of time withstand a treatment with water without amorphizing, reduction of the BET surface area or structure deformation.

By titano-alumino-phosphates (general formula (TiAlPO₄-n)) are meant within the framework of the present invention microporous titano-alumino-phosphates.

By the term titano-alumino-phosphate is meant within the framework of the present invention as defined by the International Mineralogical Association (D. S. Coombs et al., Can. Mineralogist, 35, 1997, 1571) a crystalline substance from the group of aluminium phosphates with a spatial network structure. The present titano-alumino-phosphates preferably crystallize in the CHA structure (chabazite), and are classified according to IUPAC (International Union of Pure and Applied Chemistry) and the “Structure Commission of the International Zeolite Association” on the basis of their pore size. The three-dimensional structure has annular 8-membered structural units as well as single- and double-bonded 6-membered rings which are connected to regular, three-dimensional spatial networks. The spatial network structure has characteristic pores and channels which can be bonded together again via the corner-connected tetrahedra (TiO₄, AlO₄, SiO₄, PO₄) in one, two or three dimensions. The Ti/Al/P/Si tetrahedra are called the primary structural units the connecting of which results in the formation of secondary structural units.

Starting from alumino-phosphates, so-called silico-titano-alumino-phosphates which correspond to the general formula ((Siₓ)Ti_{y}Al_{z}Pᵥ)O₂ (anhydrous and hydrogen-free) are obtained by the isomorphic substitution of phosphorus with for example silicon.

Wherein:

((Siₓ)Ti_{y}Al_{z}Pᵥ) O₂ with O≦x,y,z,v≧1, with (Siₓ)Ti_{y}Al_{z}Pᵥ)O₂, wherein 0<x<0.09, 0.01<y<0.11, 0.40<z<0.55, 0.35<v<0.50 and x+y+z+v=1.

In the case of metal-exchanged titano-alumino-phosphates, (silico-)titano-alumino-phosphates are obtained which correspond to the general formula ((Siₓ)Ti_{y}Al_{z}PᵥMᵤ)O₂ (anhydrous and hydrogen-free), with O≦x, y, z, v, u≧1, with (Siₓ)Ti_{y}Al_{z}PᵥMᵤ)O₂, wherein 0<x<0.09, 0.01<y<0.110, 0.40<z<0.55, 0.35<v<0.50, 0.01<u<0.09 and x+y+z+v+u=1.

A titano-silico-alumino-phosphate doped or metal-exchanged with transition metal cations preferably has the following formula:

[(TiₓAl_{y}Si_{z}P_{q})O₂]^{-a}[M^{b+}]_{a/b},

wherein the symbols and indices used have the following meanings: x+y+z+q=1; 0.010≦x≦0.110; 0.400≦y≦0.550; 0≦z≦0.090; 0.350≦q≦0.500; a=y−q (with the proviso that y is preferably greater than q); M^{b+} represents the cation with the charge b+, wherein b is an integer greater than or equal to 1, preferably 1, 2, 3 or 4, even more preferably 1, 2 or 3 and most preferably 1 or 2.

The heat exchanger module according to the invention contains as adsorbent a titano-alumino-phosphate which has a BET surface area of between 150 m²·g⁻¹ and 900 m²·g⁻¹. Titano-alumino-phosphates with a large BET surface area can adsorb a great deal more water than structures with smaller BET surface area. This has the advantage that less material is needed for the same adsorption capacity and the method becomes more efficient.

The heat exchanger module according to the invention contains a titano-alumino-phosphate which, even after a hydrothermal treatment at a temperature of 90° C., still has at least 50% of its BET surface area intact. The BET surface area is deemed to be intact when it has the characteristic structure of the titano-alumino-phosphates, has not been amorphized and is suitable for the adsorption of water. With the silico-alumino-phosphates and zeolites known from the state of the art, the hydrothermal stability vis-à-vis water and heat is very low. Long-term tests have shown that the BET surface area of the silico-alumino-phosphates already decreases to below 20% of the initial BET surface area after a hydrothermal treatment at a temperature of 50° C. (see Table 1). Titano-silico-alumino-phosphates can therefore be used in heat exchanger modules for longer, approx. 500 times more often than pure silico-alumino-phosphates, as a result of which the material and operating costs are reduced.

Titano-alumino-phosphates are particularly suitable which have a partial replacement of phosphorus by silicon in the framework structure, with a Ti/Si/(Al+P) ratio of 0.01:0.01:1 to 0.2:0.2:1, preferably 0.01:0.01:1 to 0.1:0.1:1, as in this ratio the hydrothermal long-term stability, in addition to high adsorption capacity and reversible desorption, is at its highest.

The titano-alumino-phosphate can be used in the heat exchanger module according to the invention as binder-containing or binder-free granular material, pellets or compacts (tablets), as a result of which the incorporation into the module and the introduction is made easier.

Furthermore, the titano-alumino-phosphate can be used as extrudate in the heat exchanger module according to the invention.

Advantageously, the titano-alumino-phosphate can also be present in a coating on a shaped body. The shaped body can assume any geometric shape, such as e.g. hollow articles, sheets, grids or honeycombs. The application is usually carried out as suspension (washcoat) or can be carried out with any further method known per se to a person skilled in the art. Furthermore, the shaped body can also consist completely of a titano-alumino-phosphate which can be obtained by pressing, optionally accompanied by the addition of a binder and/or excipient, and drying.

The use of the titano-alumino-phosphate as shaped body in a heat exchanger module is particularly advantageous because the adsorbent in the adsorption container in the adsorption device can thus be integrated in space-saving manner in a heat exchanger module according to the invention, and in addition has a simple handling.

It is furthermore advantageous if the titano-alumino-phosphate is present in the heat exchanger module according to the invention as bulk granular material or the shaped body in the form of small spheres, cylinders, beads, filaments, strands, small sheets, cubes, or agglomerates, as the adsorptive surface of the titano-alumino-phosphate is thus increased, which makes possible a particularly efficient take-up of water vapour and water.

The use as shaped body is advantageous because the adsorbent can thus be integrated in space-saving manner in the heat exchanger module, and a heat exchanger can also be used as a mobile, portable device.

The alumino-phosphate is used, according to the invention, as fixed bed or loose material packed bed. A loose titano-alumino-phosphate packed bed or titano-alumino-phosphate introduced into the fixed bed is particularly suitable as it can be easily introduced into the heat exchanger module and the handling is made easier.

The heat exchanger module according to the invention has a negative pressure in the inner space. Because the cycle of adsorption and desorption is carried out at lower pressures, or slight negative pressure, small quantities of energy are already sufficient to remove the adsorbed water again. The regeneration of the aqueous titano-alumino-phosphate is thereby made easier and in addition energy and cost savings are made. As a result of the negative pressure in the inner space, the conversion of the condensed water to cold water vapour at the cooler end of the heat exchanger module into the gas phase is made easier, whereby only very low temperatures of between 20° C. and 40° C. are needed for this, which further results in a reduction of the energy and associated costs.

The heat exchanger module according to the invention further contains a heat source. As titano-alumino-phosphates can already be regenerated at low temperatures and reversibly release the adsorbed water, not only heat sources such as heat radiators, a hot-air fan, an infrared radiator or a microwave radiator, but also heat storage media can be used. As a result, only a low expenditure of energy is needed to regenerate aqueous adsorbents. The evaporation of the water condensed out is further important. This can be converted to the gas phase again by the action of low heat, in order to be adsorbed again at the adsorbent accompanied by the release of adsorption heat.

The heat source can also be used in time-controlled manner, e.g. only after a predetermined time after the start of regeneration. It is thus ensured that not too much heat is released, as well as that the evaporation of the condensed water can also be used for cooling, for example as an air-conditioning unit in rooms. Furthermore, the heating device can be set up such that it guarantees a continuously constant temperature, while avoiding overheating of the heat exchanger module, in order to guarantee a cyclic process in which adsorption and desorption run continuously accompanied by the release of heat energy, or the surrounding area is cooled.

In the heat exchanger module according to the invention, both regenerative and non-regenerative energy can be used as heat source. Because of the low temperatures, regenerative heat sources, such as solar energy, can also be used to heat the aqueous adsorbent and to recover it. This has a decisive advantage to the extent that the operating costs for a heat exchanger module according to the invention can be lowered even further. Furthermore, energy from the storage media can be used in the sense of thermal management. As the titano-alumino-phosphate can already be regenerated at low temperatures, or condensed water is already converted to the gas phase with the help of the evaporator by the action of a little energy, low temperatures and low expenditures of energy are already sufficient for this. According to the invention, however, burner units can also be used operated with non-regenerative energy sources, such as e.g. gas, oil, electricity, etc.

A heat exchanger module within the meaning of the present invention can be used both for heating and for cooling. Titano-alumino-phosphates integrated into heat exchanger modules according to the invention adsorb water, water vapour or moisture accompanied by the release of heat energy. The released heat energy is stored, and further used, but can also be discharged to the surrounding area, to objects, appliances, devices or rooms, etc. so that these are heated. Thus, for example a moist room or object can have moisture removed from it and be dried and simultaneously heated, whereby the drying is also improved and made easier.

A heat exchanger module according to the invention, but not hermetically sealed, can be used not only for dehumidification but also for humidification. Aqueous adsorbent discharges fine water vapour to the surrounding area under the action of heat. Thus, for example an air-conditioned room can be kept at an air humidity of from 40% to 70%, as values over 40% air humidity are deemed to be ideal for health.

Likewise, a cold room, object, etc. can be heated by a heat exchanger module. By bringing it into contact with a heat exchanger module according to the invention, in the hermetically sealed system there is released in the module, by the continuous procedure of adsorption of water and heat-induced desorption, heat energy which is made usable, is either stored via heat-storage media and then released or is discharged directly to the surrounding area for example as a hot air stream.

The adsorbed water desorbs from the aqueous adsorbent in the heat exchanger module by the action of heat. The water passes into the gas phase and is condensed on the cold condenser as hot water vapour. Heat energy, which is discharged to the surrounding area via heat-storage media or directly to heat objects, appliances, devices or rooms, is released by the condensation. The temperature drop between hot adsorber/desorber and cold condenser/evaporator is at least 10° C. to 90° C., so that the degree of efficiency is maximal (Carnot process).

By switching off the heat source on the aqueous adsorbent when all the water has been removed from the aqueous adsorbent and dry, regenerated titano-alumino-phosphate has been obtained, hot water vapour still continues to condense on the cold, unheated area of the module, the condenser. For example surface condensers in the form of the tube bundle heat exchanger, double pipe heat exchanger, spiral heat exchanger or plate heat exchangers can be used as condenser/evaporator. Due to the endothermic process of the phase transition of the water vapour from gas to liquid during the condensation, energy is extracted from the surrounding area, whereby the latter is cooled down. If the heat exchanger module is in direct contact with the surrounding area, for example a room, objects, appliances or a device, these are cooled down to below the ambient temperature. Thus, a room for example in the summer can be air-conditioned by using a heat exchanger module according to the invention, by using the heat exchanger module as an air-conditioning unit, based on a titano-alumino-phosphate. It is advantageous that such an air-conditioning unit can be used not only for cooling, but also for heating, dehumidification or humidification of rooms, etc.

By a little heating in the colder area of the heat exchanger module in which the condenser/evaporator (such as e.g. surface condensers in the form of tube bundle heat exchangers, double pipe heat exchangers, spiral heat exchangers or plate heat exchangers) is located, the condensed water is converted from the liquid phase to the gas phase and obtained as cold water vapour which is adsorbed again on the adsorbent accompanied by the release of heat energy. The heat energy being released is stored in heat-storage media, and made usable, or can be used direct in the surrounding area to heat objects, appliances, devices or rooms, etc.

The cyclic process according to the invention for adsorption and desorption of water accompanied by heating or cooling of objects, appliances or rooms by means of a heat exchanger module containing an adsorber or desorber and a condenser or evaporator comprises the following steps of
a) adsorbing water by the adsorber, obtaining aqueous adsorber,
b) desorbing water from the aqueous adsorber by means of heat, obtaining water vapour and dry adsorber,
c) condensing water vapour on the evaporator, accompanied by the release of heat energy and cooling of the evaporator,
d) adding energy to the evaporator to evaporate the condensed water, obtaining cold water vapour,
e) adsorbing cold water vapour on the adsorber, obtaining aqueous adsorber, accompanied by the release of adsorption heat,
f) carrying out steps a) to e) one or more times.

By “heat exchanger” is meant according to the invention an evacuated, hermetically sealed module which is equipped with a titano-alumino-phosphate as adsorber or desorber at one end and an evaporator or condenser at the other end. In a first step, with the help of heat, for example of a gas fuel cell, the adsorber or desorber in the desorption phase is heated to up to 80° C. to 150° C. As an adsorber according to the invention releases adsorbed water again at high temperatures, the water desorbs, is removed from the adsorber. Thus, water vapour is obtained by the desorption and dry adsorber. The hot water vapour is transported in the hot air stream into the colder, i.e. unheated, area of the module, to the condenser or evaporator. The hot water vapour condenses on the evaporator or condenser accompanied by the release of heat energy, which can be discharged and used further as useful heat. The adsorber is heated until all of the adsorbed water is desorbed. After completed desorption, a dry adsorber is obtained, the gas fuel cell is switched off, whereby the temperature in the area of the evaporator or condenser in the module cools down to below ambient temperature and the condenser or evaporator cools. Energy in the form of heat is now fed to the condenser or evaporator in order to obtain cold water vapour. As soon as the temperature of the condenser or evaporator has fallen below the ambient temperature, heat is fed in from outside, in order that the water condensed out is heated and can be adsorbed at the other end as cold vapour. The cold water vapour is adsorbed on the adsorber or desorber, obtaining aqueous adsorber, accompanied by the release of adsorption heat which can be discharged as useful heat. The cycle ends with the complete evaporation of the water, and the subsequent adsorption of the cold water vapour on the adsorber or desorber, and a new adsorption and desorption cycle comprising steps a) to e) can begin.

In addition to the above-described closed heat exchanger according to the invention, open heat exchangers can also be realized within the meaning of the invention. Thus, the closed heat exchanger according to the invention can serve directly to transport the air used for heating or cooling (or a further carrier medium which can transport water vapour). An air stream or a liquid, water, etc., is fed into the open heat exchanger. This is heated by a heat source, for example a heating device, etc. The hot air stream or the heated water is directed past the open heat exchanger which contains an aqueous adsorber/desorber. Utilizing thermal management, the aqueous adsorber/desorber is regenerated by the heated air stream, water, etc. accompanied by desorption. The water is removed from the open heat exchanger by a further air stream. The air stream heats up at the hot heat exchanger and takes up the released water vapour from the adsorber/desorber and conducts it out of the open heat exchanger module. Once the water vapour has been removed from the open heat exchanger module, the adsorber/desorber cools down, and can thus take up water again. By adding aqueous air, the adsorber/desorber now adsorbs the water, wherein adsorption heat is released as heat energy, and heats the air stream now free of water. The now hot air stream can further be used to heat for example appliances, devices or other air streams. Thus, the energy being released is further used in the sense of thermal management. The aqueous adsorber/desorber can then be heated again by hot air streams, whereby a cyclic process in the sense of the invention results.

The principle of the open heat exchanger module according to the invention can be implemented for example in a dishwasher. Thus, cold mains water is pumped into a dishwasher after the start of a washing programme and heated or warmed up there. In the case of a dishwasher which contains a titano-alumino-phosphate as adsorbent, this can be operated utilizing thermal management. For this, the now hot, used mains water, or waste water, is conducted past the titano-alumino-phosphate heat exchanger before being pumped out, whereby the heat exchanger heats up. As a result of the heating of the heat exchanger, the aqueous titano-alumino-phosphate located therein is heated. The water desorbs from the titano-alumino-phosphate, wherein the adsorbed water is removed by blowing cold ambient air through the heat exchanger. The cold ambient air heats up on the hot titano-alumino-phosphate, takes up the desorbed water from the titano-alumino-phosphate in the form of water vapour in the heat exchanger and transports it out of the heat exchanger. Also after the washing water has been pumped out, cold ambient air is further blown through the heat exchanger and the titano-alumino-phosphate, whereby the anhydrous adsorbent, the titano-alumino-phosphate, cools down to ambient temperature. The cold titano-alumino-phosphate in the cooled heat exchanger can now adsorb water vapour again. The blown-in aqueous air or the water vapour is dried by the titano-alumino-phosphates, wherein adsorption energy is released in the form of heat. This additionally heats up the air, with the result that heated, dried air is obtained. This air can now be used to dry the dishes. In this way, the heat of the waste water, which is used to heat and regenerate the aqueous titano-alumino-phosphate, is used according to the invention in the sense of thermal management to heat the drying air. At the end of a washing process, the heat exchanger contains aqueous titano-alumino-phosphate which is regenerated and can be used again in the next washing process by the heated washing water.

In the cyclic process according to the invention, a titano-alumino-phosphate is used as adsorber, which reversibly releases the adsorbed water again already under the action of heat of from 20° C. to 120° C., preferably under the action of heat of from 30° C. to 100° C., preferably under the action of heat of from 40° C. to 90° C. Because a regeneration of the adsorber, obtaining dry adsorbent, is already possible at low temperatures, a lot of energy can thus be saved during the desorption of the adsorbed water. A cyclic process according to the invention thereby becomes particularly energy-efficient, as the use of the process in heat exchanger modules requires that as much energy as possible flows into the heating or cooling of devices, objects and rooms.

In the cyclic process according to the invention, a small supply of heat at the evaporator of 10° C. to 90° C. is already sufficient to obtain cold water vapour. Even small amounts of heat from an external, regenerative or non-regenerative energy or heat source are sufficient to obtain cold water vapour, which is reversibly adsorbed on the adsorber, on the condenser/evaporator starting from condensed water. The amount of heat needed for this can additionally be reduced by evacuating the module. According to the invention the evaporator/condenser serves to condense hot desorbed water vapour accompanied by the release of heat energy, as well as to convert the condensed water back into the gas phase as cold water vapour by the action of heat, and accordingly consists for example of corrosion-resistant materials, such as copper or stainless steel. By using passivating additions of pH buffers, such as NaHCO₃/Na₂CO₃, in the condenser sump, the range of materials used can be expanded to brass. If, instead of water, another heat-transfer medium is chosen according to the invention, attention should be paid to corrosion resistance according to the state of the art. This applies in particular to organic compounds which, by corrosion, can form gaseous decomposition products which increase the total pressure in the system, and thus can significantly reduce the performance of a closed system.

Because of the low temperatures that have to be applied to desorb the water from the titano-alumino-phosphate and are necessary to evaporate the condensed water, the cyclic process can also run when the temperature difference between the desorption heat source and the evaporation heat source is small.

In the cyclic process according to the invention, heat energy and adsorption energy being released is discharged and made usable. The heat energy being released can be stored by heat-storage media, or used directly to heat rooms, objects, appliances or devices.

The storage system can consist for example of a water-recirculation system which takes up the heat energy and adsorption heat being released and uses it to heat up the aqueous adsorbate or to evaporate the condensate, which releases heat energy, is thereby cooled and heated up again by renewed adsorption and condensation in the heat exchanger system.

Furthermore, the cyclic process is also used to cool rooms, objects, appliances and devices, by the reduction of the temperature in the heat exchanger module because of the condensation of hot water vapour after switching off the adsorber/desorber heat source.

To illustrate the present invention and its advantages it is described by means of the following examples without these being understood to be limiting.

There are shown in:

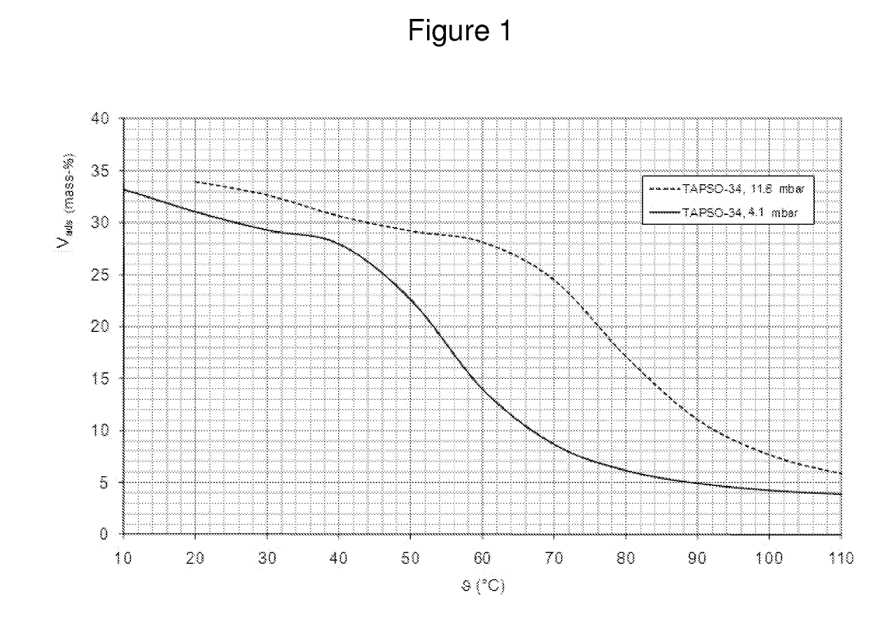

FIG. 1: the water adsorption rate and water desorption rate of a titano-alumino-phosphate, as a function of temperature and absorbed volume of water in percent by weight [wt.-%], at 4.1 mbar and at 11.6 mbar water vapour pressure.

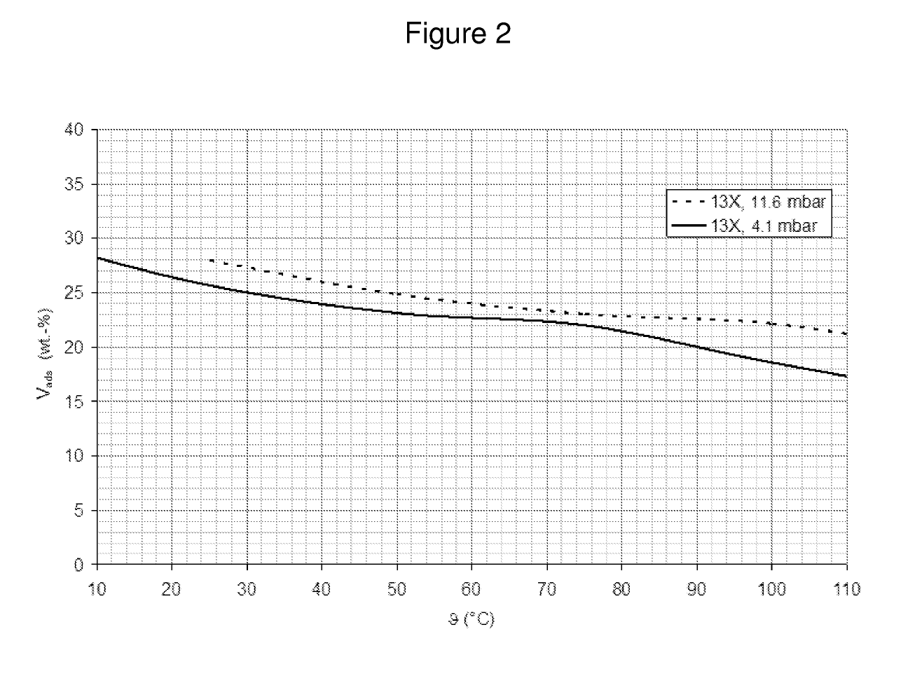

FIG. 2: the water adsorption rate and water desorption rate of the zeolite 13 X, of the state of the art, as a function of temperature and absorbed volume of water in percent by weight [wt.-%], at 4.1 mbar and at 11.6 mbar water vapour pressure.

### METHOD PART

Methods and appliances used are listed below, but are not to be regarded as limitative.

Determination of the BET Surface Area:

The BET surface area was determined according to DIN 66131 (multi-point determination), as well as according to DIN ISO 9277 (European Standard issued 2003-05) in accordance with the determination of the specific surface area of solids by gas adsorption according to the BET method (according to Brunauer, S.; Emett, P.; Teller, E. J. Am. Chem. Soc. 1938, 60, 309.). Determination took place using a Gemini from Micromeritics, with reference to the manufacturer's instructions.

The temperature in the chamber was set with RTE-111-type thermostats from Neslab.

TAPSO-34 from Sud-Chemie AG was used for the embodiment example.

SAPO-34 from Sud-Chemie AG was used for the comparison example.

Hydrargillite (aluminium hydroxide SH10) from Aluminium Oxid Stade GmbH, Germany, was used for the synthesis example.

Furthermore, silica sol (Köstrosol) with 1030.30% silicon dioxide from CWK Chemiewerk Bad Köstritz GmbH, Germany, was used.

The silicon-doped titanium dioxide TiO₂ 545 S was obtained from Evonik, Germany.

To investigate the adsorption and desorption capacity of the titano-alumino-phosphate, an “IGA003”-type pressure chamber from Hiden Analytical was used.

The water vapour needed was produced in situ from a liquid reservoir. The measurement was carried out statically under vacuum. Before the measurement, vacuum tightness and high vacuum were set (<10⁻⁵ mbar, externally to the high-vacuum connection with a Pfeiffer “IKR 261”-type appliance).

The water vapour pressure was controlled inside the appliance by means of two “Baratron”-type pressure sensors from MKS.

The temperature in the chamber was set with RTE-111-type thermostats from Neslab.

TAPSO-34 from Sud-Chemie AG was used for the embodiment example.

Zeolite 13 X from Sud-Chemie AG was used for the comparison example.

Heat Exchanger Test:

To determine the hydrothermal long-term stability of a titano-alumino-phosphate, in comparison a silico-alumino-phosphate (SAPO-34) and a titano-silico-alumino-phosphate (TAPSO-34) were treated with water over a long period of time at different temperatures.

The silico-alumino-phosphate (SAPO-34) was used as comparison substance because of its high adsorption capacity vis-à-vis water, as well as because of the identical structure, as it is likewise a small-pored molecular sieve with CHA structure.

Long-term stress tests were carried out to show whether titano-silico-alumino-phosphates in comparison with silico-alumino-phosphates withstand a treatment with and in water for 72 h at 30° C., 50° C., 70° C. and 90° C. This was determined with the help of the BET surface area in order to thus obtain information about the degree of the amorphization with regard to the structure deformation.

Test Procedure:

For the hydrothermal long-term stress test, in each case the same quantity of SAPO-34 and TAPSO-34 were treated at 30° C., 50° C., 70° C. and 90° C. each for 72 h in water. The material was then filtered off, dried at 120° C. and the BET surface area was ascertained. The molecular sieve SAPO-34 not according to the invention and not containing titanium already displays a smaller BET surface area than a comparable titanium-containing molecular sieve TAPSO-34 when untreated. While TAPSO-34 only displays a little destruction of the BET surface area depending on the temperature, and still retains over 50% of the original BET surface area after a treatment at 90° C. over a period of 72 h, with SAPO-34 the BET surface area already falls to 77% of the original BET surface area after a treatment at 30° C. over a period of 72 h. In contrast to this, TAPSO-34 still has over 99% of the original BET surface area after a 72-hour treatment with water at 30° C. After 72 h in water at 50° C. the structure of SAPO-34 is almost completely destroyed, after 72 h at 70° C. barely any structure remains, and after a treatment at 90° C. SAPO-34 is completely amorphized and the structure is completely destroyed.

The long-term stress test thus shows that SAPOs not containing titanium already lose their structure after a 72-hour treatment at 50° C. and already become amorphous at 70° C. However, even after a stress test at 70° C., titanium-containing molecular sieves according to the invention (TAPSOs) retain their structure, and display an amorphization of 50% only after a treatment at 90° C. (see Table 1).

This increased stability of TAPSO-34 compared with SAPO-34 is advantageous in particular for use in heat exchanger modules because here the adsorbent is exposed to water and temperatures of between 30° C. and 90° C. over long periods of time (cyclic process) as the adsorption and desorption processes preferably run at these temperatures and maximal adsorption behaviour is still to be maintained even after many repetitions of the adsorption and desorption in the cyclic process.

TABLE 1
Hydrothermal long-term stress test of SAPO-34
compared with TAPSO-34 in respect of BET surface area.

| Treatment temperature/° C. | TAPSO-34 | SAPO-34 |
|---|---|---|
| Untreated | 632 | 557 |
| 30 | 626 | 429 |
| 50 | 619 | 108 |
| 70 | 604 | 8 |
| 90 | 320 | 0 |

### SYNTHESIS EXAMPLE 1

100.15 parts by weight deionized water and 88.6 parts by weight hydrargillite (aluminium hydroxide SH10) were mixed. 132.03 parts by weight phosphoric acid (85%) and 240.9 parts by weight TEAOH (tetraethylammonium hydroxide) (35% in water), as well as then 33.5 parts by weight silica sol and 4.87 parts by weight silicon-doped titanium dioxide were added to the obtained mixture, with the result that a synthesis mixture with the following composition was obtained:

A synthetic gel mixture with the following molar composition was obtained:

Al₂O₃:P₂O₅:0.3SiO₂:0.1TiO₂:1TEAOH:35H₂O

The synthetic gel mixture with the above composition was transferred into a stainless-steel autoclave. The autoclave was stirred and heated to 180° C., wherein this temperature was maintained for 68 hours. After cooling, the obtained product was filtered off, washed with deionized water and dried in the oven at 100° C. An X-ray diffractogram of the obtained product showed that the product was pure TAPSO-34. The elemental analysis revealed a composition of 1.5% Ti, 2.8% Si, 18.4% Al and 17.5% P, which corresponds to a stoichiometry of Ti_{0.023}Si_{0.073}Al_{0.494}P_{0.410}. According to an SEM analysis (scanning electron microscopy) of the product its crystal size was in the range of from 0.5 μm to 2 μm.

Test Description:

General Desorption Test:

The regeneration of the aqueous titano-alumino-phosphate can take place by heat treatment at low temperatures of from 50° C. to 100° C., if a low pressure is applied.

The desorption capacity of an aqueous titano-alumino-phosphate was tested depending on the water vapour pressure in a pressure chamber with a relative air humidity of 38% or 63% and a water vapour partial pressure of up to 20 mbar. For this, the water vapour pressure in a pressure chamber was adjusted in steps from 29 mbar up to 10⁻³ mbar at a temperature of 25° C. The quantity of water adsorbed in the adsorption-desorption equilibrium was measured. The absorption of water was measured at over 20 pressure points. After adjustment of the water vapour pressure, the change in mass to equilibration was monitored for up to 60 min.

It was shown that the adsorption-desorption equilibrium can be shifted according to the pressure applied. A water vapour pressure of 1 mbar is already sufficient for the desorption to proceed as preferred vis-à-vis the adsorption. An increase in the water vapour pressure to 3 mbar (corresponding to 9% relative air humidity at normal pressure) brings about an increase in the quantity of water adsorbed of over 20 wt.-%. This means that, despite the high humidity, the adsorption-desorption equilibrium can be shifted to desorption by increasing the water vapour pressure.

General Part of the Test Description:

The adsorption and desorption behaviour of an adsorbent was investigated depending on the temperature in a heatable pressure chamber filled with water vapour.

For this, the water vapour pressure in a pressure chamber was set to 4.1 mbar (see FIG. 1, and FIG. 2: continuous line) as well as to 11.6 mbar (see FIG. 1, and FIG. 2: dashed line).

A series of tests at different temperatures at a constant water vapour pressure of 4.1 mbar was carried out first, followed by a further series of tests at different temperatures at a constant water vapour pressure of 11.6 mbar in the pressure chamber.

The series of tests were carried out at temperatures of from 10° C. to 110° C., in each case at 4.1 mbar as well as at 11.6 mbar. The temperature was set in the pressure chamber with a thermostat and only when the temperature had been held constant for 10 min was a corresponding quantity of adsorbent added to the pressure chamber via a corresponding valve.

### EMBODIMENT EXAMPLE

TAPSO-34 was used in the embodiment example.

The series of tests at 4.1 mbar water vapour pressure show, for low temperatures of from 10° C. to 40° C., that a lot of water is adsorbed. The values of the adsorbed water here lie in a range of from 30 wt.-% to approx. 35 wt.-% (see FIG. 1).

If the temperature is increased, the adsorption rate of adsorbed water falls from 30 wt.-% to approx. 5 wt.-% in the temperature range of from 40° C. to 70° C. (FIG. 1).

In contrast, in the temperature range of from 80° C. to 110° C. the adsorption rate of adsorbed water barely falls at all. In this temperature range, the adsorption rate remains relatively constant, at approximately below 5 wt.-% of adsorbed water (FIG. 1).

At a higher water vapour pressure of 11.6 mbar (FIG. 1, dashed line), the fall in the adsorption rate is delayed. In the temperature range of from 20° C. to 60° C., the adsorption rate of the adsorbed water remains relatively constant at 35 wt.-% to 30 wt.-%.

With a temperature increase to 70° C., the adsorption capacity of the TAPSO-34 begins to fall. A stronger decrease in the adsorption rate begins at a temperature of from 70° C. to 90° C. (25 wt.-% to 5 wt.-% of adsorbed water).

The lowest adsorption rates of the TAPSO-34 are at temperatures of over 90° C., here the adsorption rate approaches approximately 5 wt.-%.

With the help of FIG. 1, it becomes clear that TAPSO-34 adsorbs less water at higher temperatures and the adsorption rate falls. Adsorption and desorption are competing with each other. The equilibrium shifts towards desorption at higher temperatures.

Depending on the pressure, a stronger desorption thus already takes place at over 40° C. at 4.1 mbar. This means that low temperatures are already sufficient to reversibly remove the adsorbed water from TAPSO-34.

### COMPARISON EXAMPLE

A corresponding quantity of zeolite 13 X was used in the comparison example. The zeolite 13 X belongs to the FAU structure class, to the group of the zeolite X, which in particular also contains the group of the faujasites. Zeolite 13 X has a pore size of 13 Å, and is used as molecular sieve for the adsorption of water and water vapour.

The comparison example of zeolite 13 X shows (FIG. 2) that the adsorption rate is only slightly influenced by the temperature. Here no shift of the adsorption-desorption equilibrium takes place within the investigated temperature range of from 10° C. to 150° C.

FIG. 2 shows that the water vapour pressure has only very little influence on the adsorption behaviour of zeolite 13 X.

The slow fall in the adsorption rate shows that a much higher temperature (>>150° C.) is necessary for a reversal of the adsorption-desorption equilibrium. This means that in order to regenerate aqueous zeolite 13 X a temperature many times higher than was investigated in the test is necessary.

1-22. (canceled)

23. A heat exchanger module with thermal management comprising a titano-alumino-phosphate as adsorbent.

24. The heat exchanger module according to claim 23, wherein the titano-alumino-phosphate is a regenerative titano-alumino-phosphate (TAPO).

25. The heat exchanger module according to claim 24, wherein the titano-alumino-phosphate is a microporous titano-alumino-phosphate (TAPO), selected from TAPO-5, TAPO-2, TAPO-11, TAPO-16, TAPO-17, TAPO-18, TAPO-20, TAPO-31, TAPO-34, TAPO-35, TAPO-36, TAPO-37, TAPO-40, TAPO-41, TAPO-42, TAPO-44, TAPO-47, and TAPO-56.

26. The heat exchanger module according to claim 24, wherein the titano-alumino-phosphate contains at least one metal selected from silicon, iron, manganese, copper, cobalt, chromium, zinc, and nickel.

27. The heat exchanger module according to claim 25, wherein the titano-alumino-phosphate is doped with a further metal or semi-metal, selected from the group consisting of silicon, iron, manganese, copper, cobalt, chromium, zinc, and nickel.

28. The heat exchanger module according to claim 25, wherein the titano-alumino-phosphate displays a hydrothermal stability up to 900° C.

29. The heat exchanger module according to claim 28, wherein the titano-alumino-phosphate has a BET surface area of between 500 m²·g⁻¹ and 700 m²·g⁻¹.

30. The heat exchanger module according to claim wherein the BET surface area of the titano-alumino-phosphate after the hydrothermal treatment is at least 50% of the original value.

31. The heat exchanger module according to claim 23, wherein the titano-alumino-phosphate is represented by general formula ((SiₓTi_{y}Al_{z}Pᵥ)O₂, with 0<x,y,z,v≧1, with (Siₓ)Ti_{y}Al_{z}Pᵥ)O₂, wherein 0<x<0.09, 0.01<y<0.11, 0.40<z<0.55, 0.35<v<0.50 and x+y+z+v=1.

32. The heat exchanger module according claim 31, wherein the titano-alumino-phosphate has a Ti/Si/(Al+P) ratio of from 0.01:0.01:1 to 0.2:0.2:1.

33. The heat exchanger module according to claim 23, characterized in that the titano-alumino-phosphate is present as bulk binder-containing or binder-free granular material, as extrudate, compact or tablet.

34. The heat exchanger module according to claim 23, wherein the titano-alumino-phosphate is present in a coating on a shaped body.

35. The heat exchanger module according to claim 33, wherein the hulk granular material is present in the form of small spheres, cylinders, beads, filaments, strands, small sheets, cubes, or agglomerates.

36. The heat exchanger module according to claim 35, wherein the granular material is present as fixed bed or loose material packed bed.

37. The heat exchanger module according to claim 34, wherein the shaped body is present in the form of small spheres, cylinders, beads, filaments, strands, small sheets, cubes, or agglomerates.

38. The heat exchanger module according to claim 37, wherein the shaped body is present as fixed bed or loose material packed bed.

39. The heat exchanger module according to claim 23, wherein there is negative pressure in the module.

40. The heat exchanger module according to claim 23, wherein the module is heatable via a heat source.

41. The heat exchanger module according to claim 40, wherein both regenerative and non-regenerative energy can be used as heat source.

42. The heat exchanger module according to claim 23, wherein the heat exchanger module can be used both for heating and for cooling.

43. A cyclic process for adsorption and desorption of water accompanied by heating or cooling of objects, appliances or rooms by means of a heat exchanger module containing an absorber or desorber and a condenser or evaporator according to claim 23, comprising the steps of
a) adsorbing water by the absorber, obtaining aqueous adsorber,
b) desorbing water from the aqueous adsorber by means of heat, obtaining water vapour and dry adsorber,
c) condensing water vapour on the evaporator, accompanied by the release of heat energy and cooling of the evaporator,
d) adding energy to the evaporator to evaporate the condensed water, obtaining cold water vapour,
e) adsorbing cold water vapour on the absorber, obtaining aqueous adsorber, accompanied by the release of adsorption heat,
f) carrying out steps a) to e) one or more times.

44. The cyclic process according to claim 43, wherein the absorber already desorbs the adsorbed water again under the action of heat of from 40° C. to 80° C.

45. The cyclic process according to claim 44, wherein cold water vapour is already obtained on the evaporator with a supply of low heat of from 10° C. to 90° C.

46. The cyclic process according to claim 45, wherein the heat energy and adsorption energy being released is discharged and made usable.
